(19) United States
(12) Patent Application Publication
(10) Pub. No.: US 2006/0169143 A1
(43) Pub. Date: Aug. 3, 2006

(54) Device for storing compressed gas

(75) Inventors: Thomas Troster, Salzkotten (DE); Norbert Austerhoff, Lotte (DE); Ingo Hermann, Mainz (DE); Florian Mertens, Frankfurt/Main (DE); Holger Winkelmann, Mainz-Kastel (DE)

Correspondence Address: Henry M. Feiereisen;Henry M. Feiereisen, LLC, Suite 4714, 350 Fifth Avenue, New York, NY, 10118, US

(73) Assignee: Benteler Automobiltechnik GmbH, Paderborn (DE)

(21) Appl. No.: 11/324,737

(22) Filed: Jan. 3, 2006

(30) Foreign Application Priority Data
Jan. 12, 2005 (DE) 10 2005 001 592.1

(51) Int. Cl. B01D 53/02

(52) U.S. Cl. 96/135

(57) ABSTRACT

A device for storing compressed gas includes a cylindrical pressure vessel having inlet and outlet conduits for a cooling/heating fluid and for compressed gas. Arranged in the interior of the pressure vessel are plural storage layers which are separated from one another and contain solid matter for charging with compressed gas. The storage layers have a volume, which depends on a charging state of the storage layers with compressed gas, and are separated dust-tight from one another about their circumference. Bounding one side of each storage layer is a spring layer which assumes a filtering function with respect to the solid matter of the storage layer, wherein the solid matter in the storage layer is charged with compressed gas via the spring layer or compressed gas is discharged from the solid matter in the storage layers via the spring layer. The other opposite side of the storage layer is bounded by a gastight cooling/heating layer for passage of the cooling/heating fluid.

### CROSS-REFERENCES TO RELATED APPLICATIONS

This application claims the priority of German Patent Application, Serial No. 10 2005 001 592.1, filed Jan. 12, 2005, pursuant to 35 U.S.C. 119(a)-(d), the subject matter of which is incorporated herein by reference.

### BACKGROUND OF THE INVENTION

The present invention relates, in general, to a device for storing compressed gas.

Nothing in the following discussion of the state of the art is to be construed as an admission of prior art.

U.S. Pat. No. 6,432,176 discloses a storage reservoir having a cylindrical pressure vessel with feed and discharge lines for a cooling/heating fluid as well as compressed gas, in particular hydrogen. The pressure vessel has an interior for accommodating separated storage layers which contain solid matter and which can be charged with compressed gas. The volumes of the storage layers are dependent on the charging state with compressed gas.

For application in, e.g., vehicle drives, hydride-forming metals or metal alloys can be used to realize a continuous, loss-free and safe storage of hydrogen. These materials, which become powdery after repeated hydrogenating and dehydrogenating (charging and discharging), absorb hydrogen by a reversible chemical reaction that generates heat which can then be removed by an appropriate cooling fluid. Applying heat reverses this chemical reaction, resulting in a desorption (liberation) of hydrogen. The reaction of metal hydride with hydrogen is accompanied with a change in volume of the storage layers of up to 30% depending on the used metal hydride.

Storage reservoirs for storing hydrogen in metal hydrides have to comply with certain standards. For example, it is required to realize storage in metal hydride without material loss. In other words, removal of dust from the metal hydride by the hydrogen flow must be prevented through use of a suitable filter. Moreover, the heat exchange should be executed as fast as possible as the storage layers are charged with hydrogen and discharged from hydrogen. Also, a change in volume of the storage layers must be taken into account during the charging and discharging processes. Further, no displacement of the metal hydride may take place during travel, because relatively great changes in volume may cause an undesired distribution of the metal hydride that could lead to a destruction of the pressure vessel. Finally, during transfer of hydrogen into or from the storage layers, the wall of the pressure vessel must be able to withstand pressure which dependent on the metal hydride and the charging speed during charging process can reach up to 50 bar.

Regardless whether constructed in the form of a single tube or in the form of a tubular heat exchanger with bundles of tubes, the storage reservoir is heavy and voluminous so that its use in a motor vehicle is impractical. Also the storage capacity for the metal hydride is inadequate and the weight of the individual components of such storage reservoirs is unfavorable. Furthermore, the hydrogen exchange with the metal hydride via centrally gas-permeable tubes, mostly of sintered metal, is limited locally so that the overall construction becomes cost-intensive. In addition, the heat exchange and thus the charging time of the storage layers is inadequate as a result of the comparably small heat exchange surfaces and because metal hydride is mostly charged partially only. Also, the incorporation of the metal hydride in the storage layers is problematic because of the possible displacement of the metal hydride.

It would therefore be desirable and advantageous to provide an improved compressed gas storage device which obviates prior art shortcomings and can be manufactured on a large scale and which allows quick charging and discharging times and requires little volume so as to be cost-efficient.

### SUMMARY OF THE INVENTION

According to one aspect of the present invention, a device for storing compressed gas includes a cylindrical pressure vessel having inlet and outlet conduits for a cooling/heating fluid and for compressed gas, with the pressure vessel being defined by an axis and having an interior, plural storage layers arranged in the interior of the pressure vessel separated from one another and containing solid matter for charging with compressed gas, with the storage layers having a volume depending on a charging state of the storage layers with compressed gas and separated dust-tight from one another about their circumference, a spring layer bounding one side of each storage layer and assuming a filtering function with respect to the solid matter of the storage layer, wherein the solid matter in the storage layer is charged with compressed gas via the spring layer or compressed gas is discharged from the solid matter in the storage layers via the spring layer, and a gastight cooling/heating layer bounding an opposite side of said storage layer for passage of the cooling/heating fluid.

The present invention resolves prior art problems by placing a modular structure with several layers inside the cylindrical pressure vessel, with each layer assuming a particular function. The pressure vessel may be made of steel or a composite. The modular structure is hereby configured to have an outer diameter substantially corresponding to the inner diameter of the pressure vessel. The spring layer not only allows a charging of the solid matter with compressed gas or its discharge but also assumes the task of a volume control as a consequence of the occurring changes in volume of the storage layer during charging and discharging. The presence of a large contact surface between the spring layer and the storage layer results also in a rapid charging of the storage layer with compressed gas and a rapid discharge. The spring layer further assumes the task of filtering. In other words, particles in the storage layer of a size greater than 5 μm are reliably kept back and thus are not removed together with the compressed gas.

The cooling/heating layer assumes the task of an abutment for the spring layer and the task of heat exchange during passage of a coolant, when the storage layer is charged or during passage of a heating fluid, when compressed gas is removed from the storage layer.

A preferred modular structure inside the pressure vessel may have the following configuration:

cooling/heating layer

storage layer

spring layer

storage layer

cooling/heating layer

storage layer

spring layer

storage layer

cooling/heating layer

The modular structure may be installed separately in the pressure vessel, thereby realizing the added advantage of a permanent surface pressure of the spring layer upon one or two storage layers. The spatial position of the compressed gas storage device is hereby secondary. The compressed gas storage device may be installed vertically or horizontally or in inclined disposition. Thus, a compressed gas storage device meets the demands for installation in available spaces in motor vehicles.

According to another feature of the present invention, the spring layers may be positioned in fluid communication about their perimeter with the interior of the pressure vessel for transfer of compressed gas. In this way, compressed gas can be transferred rapidly and evenly to and from the storage layers. Suitably, each spring layer may be provided with a jacket having spaced-apart bores about its circumference for transfer of compressed gas.

According to another feature of the present invention, a compressed gas conduit may be provided to radially extend through a wall of the pressure vessel for connection to the interior. Such a conduit may also be connected to a lid of the pressure vessel.

According to another feature of the present invention, the storage layers may be constructed in the form of metal hydride layers with defined bed height, and the compressed gas may be hydrogen.

According to another feature of the present invention, the spring layer may have a fine-pored flexible filter element adjoining the storage layer and constructed to resist mechanical loads, a spring assembly pressing the filter element flatly against the storage layer, and an abutment for support of the spring assembly. The filter element is hereby constructed to permit an unimpeded exchange of compressed gas, such as hydrogen, on one side thereof but to prevent a removal of fine dust from the solid matter, such as metal hydride, into the discharge flow of compressed gas. Moreover, the filter element is flexible enough to adjust to local changes in volume of the solid matter across the entire contact area between a storage layer and a spring layer.

The spring assembly is constructed to also adjust spontaneously to local changes in volume of the solid matter while still ensuring a continuous surface pressure upon the storage layer via the filter element. Thus, solid matter is prevented from shifting during travel of a motor vehicle. In order to act simultaneously upon two storage layers, the spring assembly may include a plurality of compressed springs. The compressed springs may hereby be disposed next to one another with their axes in parallel relationship. Suitably, the spring assembly may be traversed transversely by a buttress, with compressed springs arranged on both sides of the buttress. Thus, two spring assemblies are present. The buttress may be secured to the circumferential jacket of the spring assembly. The configuration of the spring assembly with compressed springs ensures also a reliable gas flow.

According to another feature of the present invention, the spring assembly may be constructed in the form of a wire mesh. Such a wire mesh may also be disposed between two storage layers. It may also be conceivable to support the wire mesh upon a buttress and a storage layer.

According to another feature of the present invention, the filter element may be made of a fine-meshed stainless steel web.

According to another feature of the present invention, the filter element may be made of a perforated stainless steel foil.

According to another feature of the present invention, the cooling/heating layer may lamellar configuration and provided with channels for passage of the cooling/heating fluid.

According to another feature of the present invention, the cooling/heating layer may include a conduit extending from one end surface of a lid of the pressure vessel in parallel relationship to the axis of the pressure vessel for flow of the cooling/heating fluid.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a vertical longitudinal section of a compressed gas storage device according to the present invention; and

FIG. 2 is an enlarged detailed view of the area encircled in FIG. 1 and marked II.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

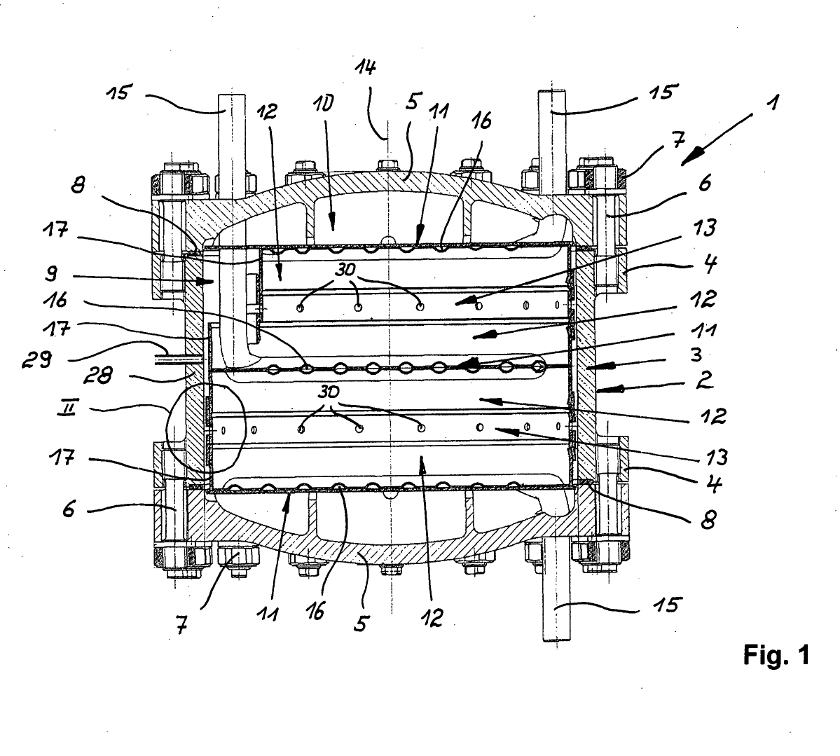

Turning now to the drawing, and in particular to FIG. 1, there is shown a vertical longitudinal section of a compressed gas storage device according to the present invention, generally designated by reference numeral 1. The storage device 1 includes a pressure vessel 2 having a central cylindrical length portion 3 and terminal flanges 4. Lids 5 are respectively bolted to the flanges 4 by screw bolts 6 and nuts 7. Sealing rings 8 are received between the central length portion 3 and the lids 5.

The pressure vessel 2 has an interior 9 for receiving a modular structure 10 comprised of several layers 11, 12, 13, which assume particular tasks, respectively. In the non-limiting example of FIG. 1, the module 10 is comprised—as viewed in axial direction of the pressure vessel 2—of a cooling/heating layer 11, a storage layer 12, a spring layer 13, a storage layer 12, a cooling/heating layer 11, a storage layer 12, a spring layer 13, a storage layer 12, and a cooling/heating layer 11.

The cooling/heating layers 11 can be supplied with a cooling/heating fluid, e.g. water or silicone oil, via respective conduits 15 which extend out from an end surface of the lids 5 of the pressure vessel 2 in parallel relationship to the axis 14 of the pressure vessel 2. The cooling/heating layers 11 have a lamellar configuration and are formed with channels 16 for flow of the cooling/heating fluid.

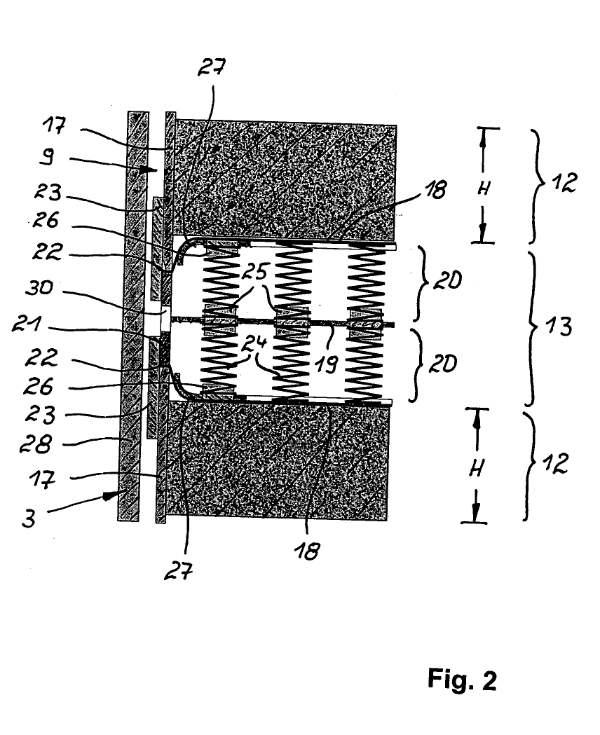

Disposed next to the cooling/heating layers 11 are the storage layers 12 which include solid matter of metal hydride. The storage layers 12 are bounded circumferentially by an outer jacket 17, on one end side by a cooling/heating layers 11, and on the opposite end side by a spring layer 13. As indicated in FIG. 2, the storage layers 12 have a defined bed height H.

As shown in particular in FIG. 2, each spring layer 13 includes two fine-pored flexible filter elements 18, which are respectively adjoining the storage layers 12 and constructed to withstand high mechanical loads, and two spring assemblies 20 by which the filter elements 18 are respectively pressed against the storage layers 12 and which are supported against a central abutment 19 and embraced by an outer circumferential jacket 21. The filter elements 18 may be made of perforated stainless steel foils or fine-meshed stainless steel web. The filter elements 18 are clamped about their peripheral edge regions 22 between the jacket 21, the jackets 17 of the adjoining storage layers 12, and circumferential collars 23.

In the non-limiting example of FIG. 2, the spring assemblies 20 include a plurality of compression springs 24 in parallel relationship. The compression springs 24 bear with one end upon the abutment 19 and with their other end upon the filter elements 18 so that the filter elements 18 are pressed upon a large area of the storage layers 12. In this way, the spring layer 13 is able to adapt to local changes in volume of the solid matter in the storage layers 12. The compression springs 24 are guided by buttresses 25 extending from the abutment 19, and by buttresses 26 connected to support rings 27 which center the edges of the filter elements 18.

Inflow and outflow of compressed gas is realized via a conduit 29 which radially extends through a wall 28 of the central length portion 3 of the pressure vessel 2. When charging the storage layers 12, compressed gas enters the interior 9 of the pressure vessel 2 through the conduit 29 and flows via bores 30 in the jackets 21 into the spring layers 13 from which compressed gas is able to flow across the entire effective area of the storage layers 12. Compressed air is also able to flow back via the spring layers 13 during the discharging process.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A device for storing compressed gas, comprising:
a cylindrical pressure vessel having inlet and outlet conduits for a cooling/heating fluid and for compressed gas, said pressure vessel being defined by an axis and having an interior;
plural storage layers arranged in the interior of the pressure vessel separated from one another and containing solid matter for charging with compressed gas, said storage layers having a volume depending on a charging state of the storage layers with compressed gas and separated dust-tight from one another about their circumference;
a spring layer bounding one side of each said storage layer and assuming a filtering function with respect to the solid matter of the storage layer, wherein the solid matter in the storage layer is charged with compressed gas via the spring layer or compressed gas is discharged from the solid matter in the storage layers via the spring layer; and
a gastight cooling/heating layer bounding an opposite side of said storage layer for passage of the cooling/heating fluid.

2. The device of claim 1, wherein the spring layer is in fluid communication about its perimeter with the interior of the pressure vessel for transfer of compressed gas.

3. The device of claim 2, wherein the spring layer is provided with an outer jacket having spaced-apart bores about its circumference for transfer of compressed gas.

4. The device of claim 1, and further comprising a compressed gas conduit radially extending through a wall of the pressure vessel for connection to the interior.

5. The device of claim 1, wherein the storage layers are constructed in the form of metal hydride layers with defined bed height, and wherein the compressed gas is hydrogen.

6. The device of claim 1, wherein the spring layer has a fine-pored flexible filter element adjoining the storage layer and constructed to resist mechanical loads, a spring assembly pressing the filter element flatly against the storage layer, and an abutment for support of the spring assembly.

7. The device of claim 6, wherein the filter element is constructed for unimpeded exchange of compressed gas on one side thereof and for preventing a removal of fine dust from the solid matter into an outgoing flow of compressed gas.

8. The device of claim 6, wherein the spring assembly includes a plurality of compressed springs.

9. The device of claim 8, wherein the compressed springs are disposed next to one another with their axes in parallel relationship.

10. The device of claim 8, wherein the spring layer has a buttress for traversal of the spring assembly, with compressed springs arranged on both sides of the buttress.

11. The device of claim 10, wherein the spring layer is provided with a circumferential outer jacket, said buttress being secured to the jacket of the spring layer.

12. The device of claim 6, wherein the spring assembly is constructed in the form of a wire mesh.

13. The device of claim 6, wherein the filter element is made of a fine-meshed stainless steel web.

14. The device of claim 6, wherein the filter element is made of a perforated stainless steel foil.

15. The device of claim 1, wherein the cooling/heating layer has a lamellar configuration and is provided with channels for the cooling/heating fluid.

16. The device of claim 1, wherein the pressure vessel has a lid, said cooling/heating layer including a conduit extending from one end surface of the lid in parallel relationship to the axis of the pressure vessel for flow of the cooling/heating fluid.

17. The device of claim 1, wherein the pressure vessel is made of steel.

18. The device of claim 1, wherein the pressure vessel is made of a composite.

19. A device for storing compressed gas, comprising:
a cylindrical pressure vessel having an interior; and
a module placed in the interior of the pressure vessel and having an outer diameter substantially corresponding to an inner diameter of the pressure vessel, said module including a storage layer containing a solid matter which can be charged with compressed gas, a filter-containing spring layer disposed coextensively on one side of the storage layer and constructed to prevent a passage of the solid matter while allowing passage of compressed gas, and a gastight cooling/heating layer disposed coextensively on an opposite side of the storage layer for passage of a heat transfer fluid.

20. The device of claim 15, wherein the module is constructed to include the following sequence of members in axial direction of the pressure vessel: cooling/heating layer—storage layer—spring layer—storage layer—cooling/heating layer—storage layer—spring layer—storage layer—cooling/heating layer.
